(19) United States
(12) Patent Application Publication
(10) Pub. No.: US 2022/0207324 A1
(43) Pub. Date: Jun. 30, 2022

(54) MACHINE-LEARNING TECHNIQUES FOR TIME-DELAY NEURAL NETWORKS

(71) Applicant: EQUIFAX INC., Atlanta, GA (US)

(72) Inventors: Howard Hugh HAMILTON, Atlanta, GA (US); Jeffrey Don DUGGER, Atlanta, GA (US)

(21) Appl. No.: 17/645,517

(22) Filed: Dec. 22, 2021

Related U.S. Application Data
(60) Provisional application No. 63/132,935, filed on Dec. 31, 2020.

(51) Int. Cl. G06N 3/04

(52) U.S. Cl. CPC G06N 3/049; G06N 3/0454

(57) ABSTRACT

Various aspects involve time-delay neural networks for risk assessment or other outcome predictions. For instance, a risk assessment computing system accesses time-series data of predictor variables associated with a target entity and determines a risk indicator for the target entity by inputting the time-series data of the predictor variables into a time-delay neural network. The time-delay neural network includes a set of attribute networks each corresponding to a predictor variable and a decision network configured to generate the risk indicator from outputs of the set of attribute networks. The risk assessment computing system further transmits, to a remote computing device, a responsive message including the risk indicator for use in controlling access to one or more interactive computing environments by the target entity.

### CROSS-REFERENCE TO RELATED APPLICATIONS

This claims priority to U.S. Provisional Application No. 63/132,935, entitled “Machine-Learning Techniques for Monotonic Time-Delay Neural Networks,” filed on Dec. 31, 2020, which is hereby incorporated in its entirety by this reference.

### TECHNICAL FIELD

The present disclosure relates generally to artificial intelligence. More specifically, but not by way of limitation, this disclosure relates to machine learning using artificial neural networks for emulating intelligence that are trained for assessing risks or performing other operations and for providing explainable outcomes associated with these outputs.

### Background

In machine learning, artificial neural networks can be used to perform one or more functions (e.g., acquiring, processing, analyzing, and understanding various inputs in order to produce an output that includes numerical or symbolic information). A neural network includes one or more algorithms and interconnected nodes that exchange data between one another. The nodes can have numeric weights that can be tuned based on experience, which makes the neural network adaptive and capable of learning.

In order to make the output of neural networks explainable, monotonic neural networks can be utilized. Monotonic neural networks can enforce monotonicity between input variables and output, thereby facilitate formulating explainable relationships between the input variables and the output. However, existing monotonic neural networks evaluate the relationship between the input variables and output by using values of the input variables at a single time point. Input variables typically have values changing over time. By only evaluating the output using input variables at a given time point, these static monotonic neural networks do not fully utilize the information contained in the input variables. As a result, the prediction output by the monotonic neural network may not be accurate.

### SUMMARY

Various aspects of the present disclosure provide systems and methods for building and utilizing monotonic time-delayed neural networks for risk assessment or other outcome predictions. In one example, a method includes accessing time-series data of a plurality of predictor variables associated with a target entity, the time-series data of a predictor variable of the plurality of predictor variables comprising data instances of the predictor variable at a sequence of time points; determining a risk indicator for the target entity indicating a level of risk associated with the target entity by inputting the time-series data of the plurality of predictor variables into a time-delay neural network; and transmitting, to a remote computing device, a responsive message including the risk indicator for use in controlling access to one or more interactive computing environments by the target entity. The time-delay neural network comprises (a) a plurality of attribute networks, each attribute network of the plurality of attribute networks corresponding to a predictor variable of the plurality of predictor variables and (b) a decision network for generating the risk indicator from outputs of the plurality of attribute networks. Each attribute network of the plurality of attribute networks comprises (a) input nodes in an input layer accepting the respective data instances of the predictor variable corresponding to the attribute network and (b) a set of hidden layer nodes in a hidden layer connected to the input nodes. A first set of hidden layer nodes in a first attribute network of the plurality of attribute networks and a second set of hidden layer nodes in a second attribute network of the plurality of attribute networks are disjoint. Weights of connections associated with the set of hidden layer nodes in each attribute network of the plurality of attribute networks are subject to a constraint.

In another example, a system includes a processing device and a memory device in which instructions executable by the processing device are stored for causing the processing device to perform operations. The operations include accessing time-series data of a plurality of predictor variables associated with a target entity, the time-series data of a predictor variable of the plurality of predictor variables comprising data instances of the predictor variable at a sequence of time points; determining a risk indicator for the target entity indicating a level of risk associated with the target entity by inputting the time-series data of the plurality of predictor variables into a time-delay neural network; transmitting, to a remote computing device, a responsive message including the risk indicator for use in controlling access to one or more interactive computing environments by the target entity. The time-delay neural network comprises (a) a plurality of attribute networks each attribute network of the plurality of attribute networks corresponding to a predictor variable of the plurality of predictor variables and (b) a decision network for generating the risk indicator from outputs of the plurality of attribute networks. Each attribute network of the plurality of attribute networks comprises (a) input nodes in an input layer configured for accepting the respective data instances of the predictor variable corresponding to the attribute network and (b) a set of hidden layer nodes in a hidden layer configured to connect to the input nodes. A first set of hidden layer nodes in a first attribute network of the plurality of attribute networks and a second set of hidden layer nodes in a second attribute network of the plurality of attribute networks are configured to be disjoint. Weights of connections associated with the set of hidden layer nodes in each attribute network of the plurality of attribute networks are configured to be subject to a constraint.

In yet another example, a non-transitory computer-readable storage medium having program code that is executable by a processor device to cause a computing device to perform operations. The operations include accessing time-series data of a plurality of predictor variables associated with a target entity, the time-series data of a predictor variable of the plurality of predictor variables comprising data instances of the predictor variable at a sequence of time points; determining a risk indicator for the target entity indicating a level of risk associated with the target entity by inputting the time-series data of the plurality of predictor variables into a time-delay neural network; and transmitting, to a remote computing device, a responsive message including the risk indicator for use in controlling access to one or more interactive computing environments by the target entity. The time-delay neural network comprises (a) a plurality of attribute networks each attribute network of the plurality of attribute networks corresponding to a predictor variable of the plurality of predictor variables and (b) a decision network configured to generate the risk indicator from outputs of the plurality of attribute networks. Each attribute network of the plurality of attribute networks comprises (a) input nodes in an input layer accepting the respective data instances of the predictor variable corresponding to the attribute network and (b) a set of hidden layer nodes in a hidden layer configured to connect to the input nodes. A first set of hidden layer nodes in a first attribute network of the plurality of attribute networks and a second set of hidden layer nodes in a second attribute network of the plurality of attribute networks are configured to be disjoint. Weights of connections associated with the set of hidden layer nodes in each attribute network of the plurality of attribute networks are configured to be subject to a constraint.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of a computing environment in which a monotonic time-delayed neural network can be built and utilized for risk assessment or other outcome predictions, according to certain aspects of the present disclosure.

FIG. 2 is a flow chart depicting an example of a process for utilizing an explainable time-delay neural network to generate risk indicators for a target entity based on multiple instances of predictor variables associated with the target entity, according to certain aspects of the present disclosure.

FIG. 3 is a flow chart depicting an example of a process for building and training an explainable time-delay neural network, according to certain aspects of the present disclosure.

FIG. 4 is a diagram depicting an example of a time-delay neural network, according to certain aspects of the present disclosure.

FIG. 5A is a diagram depicting an example of an attribute network, according to certain aspects of the present disclosure.

FIG. 5B is a diagram depicting another example of an attribute network, according to certain aspects of the present disclosure.

FIG. 6 is a diagram depicting a convolution as a matrix operation on the input time-series for the predictor variable, according to certain aspects of the present disclosure.

FIG. 7 is a block diagram illustrating components of a time-delay neural network, according to certain aspects of the present disclosure.

FIG. 8 is a block diagram depicting an example of a computing system suitable for implementing aspects of the present disclosure.

### DETAILED DESCRIPTION

Certain aspects described herein are provided for building and utilizing explainable time-delayed neural network models for risk assessment or other outcome predictions. The technology described herein can address the issues associated with static neural networks discussed above. For example, instead of using a single value of an input variable for a neural network, a time-delay neural network can be built to accept a sequence of values of an input variable along the time dimension as inputs. This allows for additional historical data of the input variables to be incorporated, increasing the predictive power of the model.

For example, the time-delay neural network can include several layers such as an input layer, one or more hidden layers, and an output layer. Each node in the input layer can be configured to receive an input variable value at a given time point. Different values of an input variable at different time points (also referred to as the “instances of the input variable” or “input variable instances”) thus correspond to different input nodes. In some examples, the sequence of instances of an input variable (also referred to as the “time series data” of the input variable) is introduced to the neural network using an attribute network. The attribute network can include a set of nodes in the input layer accepting the sequence of input variable instances and one or more hidden nodes from the first hidden layer of the neural network. The hidden nodes in the attribute network can combine the sequence of input variable instances into outputs that are fed into the nodes of the next layer of the neural network, such as the second hidden layer. As a result, the neural network can include multiple attribute networks for respective input variables in the input layer and the first hidden layer.

In some examples, each of the attribute networks is configured to identify predictive features from the sequence of input variable instances. For example, an attribute network can be configured to perform convolution operations on the sequence of input variable instances. To do so, the weights of connections in the attribute network are constrained such that the set of weights of connections associated with a hidden layer node is a shifted version of the set of weights of connections associated with another hidden layer node. The output of the attribute network can contain metrics measuring the identified predictive features which can be used by the rest of the time-delay neural network (referred to herein as a “decision network”) to generate the prediction output.

To ensure the explainability of the time-delay neural network, analysis (e.g., wavelet analysis) can be performed on the parameters of the attribute networks and the input time-series data to determine the influencing components of the predictive features that the respective attribute networks are trained to extract. In addition, the decision network can be trained to be a monotonicity network. For instance, the training of the decision network can be formulated as solving a constrained optimization problem. The goal of the optimization problem is to identify a set of optimized weights for the decision network so that a loss function of the decision network is minimized under a constraint that the relationship between the output and each input is monotonic.

Explanatory data for the prediction results of a target entity can be generated by combining the explanatory data generated from the attribute networks and the explanatory data generated from the decision network. For example, the explanatory data can be generated by combining the identified components of the predictive features contained in the input sequence of variable instances and the relationship between the respective identified predictive features (inputs to the decision model) and the prediction output.

Certain aspects described herein, which can include operations and data structures with respect to neural networks that improve how computing systems service analytical queries, can overcome one or more of the issues identified above. For instance, the neural network presented herein is structured so that a sequence of input variable values at different time points, rather than a single time point, are input to the neural network. Such a structure can improve the operations of the neural network by using more comprehensive information in the input variables to predict an outcome thereby leading to more accurate prediction by the neural network. In addition, enforcing the monotonicity in the decision model and using wavelet-based analysis on the parameters of the attribute networks allow using the same neural network to predict an outcome and to generate explainable reasons for the predicted outcome.

Additional or alternative aspects can implement or apply rules of a particular type that improve existing technological processes involving machine-learning techniques. For instance, to enable the attribute networks to extract predictive features from the input sequence of variable instances, rules of imposing constraints on the weights of each attribute network are employed. In addition, to enforce the monotonicity of the decision network, a particular set of rules are employed in the training of the neural network. This particular set of rules allow monotonicity to be introduced to the decision network as a constraint in the optimization problem involved in the training of the decision network. Some of these rules allow the training of the monotonic decision network to be performed more efficiently without any post-training adjustment.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

Operating Environment Example for Machine-Learning Operations

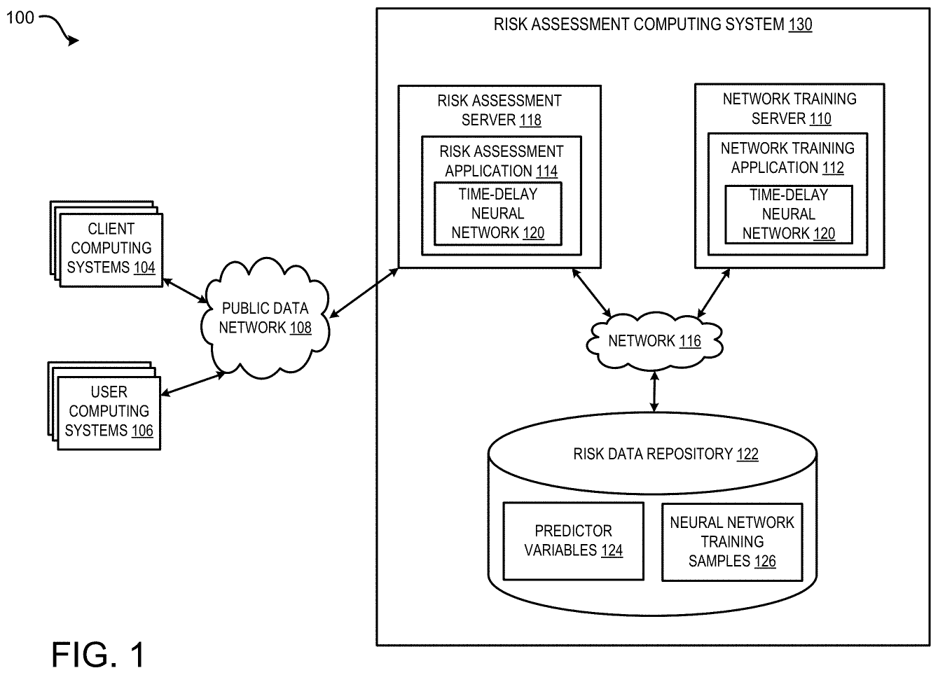

Referring now to the drawings, FIG. 1 is a block diagram depicting an example of an operating environment 100 in which a risk assessment computing system 130 builds and trains an explainable time-delay neural network that can be utilized to predict risk indicators based on predictor variables. FIG. 1 depicts examples of hardware components of a risk assessment computing system 130, according to some aspects. The risk assessment computing system 130 is a specialized computing system that may be used for processing large amounts of data using a large number of computer processing cycles. The risk assessment computing system 130 can include a network training server 110 for building and training an explainable time-delay neural network 120 (or neural network 120 in short) wherein the relationship between the input predictor variables of the neural network 120 and the output of the neural network 120 can be determined. The risk assessment computing system 130 can further include a risk assessment server 118 for performing a risk assessment for given predictor variables 124 using the trained neural network 120.

The network training server 110 can include one or more processing devices that execute program code, such as a network training application 112. The program code is stored on a non-transitory computer-readable medium. The network training application 112 can execute one or more processes to train and optimize a neural network for predicting risk indicators based on predictor variables 124 and maintaining an explainable relationship between the predictor variables 124 and the predicted risk indicators.

In some aspects, the network training application 112 can build and train a time-delay neural network 120 utilizing neural network training samples 126. The neural network training samples 126 can include multiple training vectors consisting of training predictor variables and training risk indicator outputs corresponding to the training vectors. Because the time-delay neural network 120 uses multiple instances for each predictor variable as input, the training vectors in the training samples 126 include those multiple instances of the training predictor variables. The neural network training samples 126 can be stored in one or more network-attached storage units on which various repositories, databases, or other structures are stored. Examples of these data structures are the risk data repository 122.

Network-attached storage units may store a variety of different types of data organized in a variety of different ways and from a variety of different sources. For example, the network-attached storage unit may include storage other than primary storage located within the network training server 110 that is directly accessible by processors located therein. In some aspects, the network-attached storage unit may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory or memory devices.

The risk assessment server 118 can include one or more processing devices that execute program code, such as a risk assessment application 114. The program code is stored on a non-transitory computer-readable medium. The risk assessment application 114 can execute one or more processes to utilize the neural network 120 trained by the network training application 112 to predict risk indicators based on input predictor variables 124. In addition, the neural network 120 can also be utilized to generate explanatory data for the predictor variables, which indicate an effect or an amount of impact that one or more predictor variables have on the risk indicator.

The output of the trained neural network 120 can be utilized to modify a data structure in the memory or a data storage device. For example, the predicted risk indicator and/or the explanation codes can be utilized to reorganize, flag, or otherwise change the predictor variables 124 involved in the prediction by the neural network 120. For instance, predictor variables 124 stored in the risk data repository 122 can be attached with flags indicating their respective amount of impact on the risk indicator. Different flags can be utilized for different predictor variables 124 to indicate different levels of impacts. Additionally, or alternatively, the locations of the predictor variables 124 in the storage, such as the risk data repository 122, can be changed so that the predictor variables 124 or groups of predictor variables 124 are ordered, ascendingly or descendingly, according to their respective amounts of impact on the risk indicator.

By modifying the predictor variables 124 in this way, a more coherent data structure can be established which enables the data to be searched more easily. In addition, further analysis of the neural network 120 and the outputs of the neural network 120 can be performed more efficiently. For instance, predictor variables 124 having the most impact on the risk indicator can be retrieved and identified more quickly based on the flags and/or their locations in the risk data repository 122. Further, updating the neural network, such as re-training the neural network based on new values of the predictor variables 124, can be performed more efficiently especially when computing resources are limited. For example, updating or retraining the neural network can be performed by incorporating new values of the predictor variables 124 having the most impact on the output risk indicator based on the attached flags without utilizing new values of all the predictor variables 124.

Furthermore, the risk assessment computing system 130 can communicate with various other computing systems, such as client computing systems 104. For example, client computing systems 104 may send risk assessment queries to the risk assessment server 118 for risk assessment, or may send signals to the risk assessment server 118 that control or otherwise influence different aspects of the risk assessment computing system 130. The client computing systems 104 may also interact with user computing systems 106 via one or more public data networks 108 to facilitate interactions between users of the user computing systems 106 and interactive computing environments provided by the client computing systems 104.

Each client computing system 104 may include one or more third-party devices, such as individual servers or groups of servers operating in a distributed manner. A client computing system 104 can include any computing device or group of computing devices operated by a seller, lender, or other providers of products or services. The client computing system 104 can include one or more server devices. The one or more server devices can include or can otherwise access one or more non-transitory computer-readable media. The client computing system 104 can also execute instructions that provide an interactive computing environment accessible to user computing systems 106. Examples of the interactive computing environment include a mobile application specific to a particular client computing system 104, a web-based application accessible via a mobile device, etc. The executable instructions are stored in one or more non-transitory computer-readable media.

The client computing system 104 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system 106 to access various functions of the interactive computing environment. For instance, the interactive computing environment may transmit data to and receive data from a user computing system 106 to shift between different states of the interactive computing environment, where the different states allow one or more electronic transactions between the user computing system 106 and the client computing systems 104 to be performed.

In some examples, a client computing system 104 may have other computing resources associated therewith (not shown in FIG. 1), such as server computers hosting and managing virtual machine instances for providing cloud computing services, server computers hosting and managing online storage resources for users, server computers for providing database services, and others. The interaction between the user computing system 106 and the client computing system 104 may be performed through graphical user interfaces presented by the client computing system 104 to the user computing system 106, or through an application programming interface (API) calls or web service calls.

A user computing system 106 can include any computing device or other communication device operated by a user, such as a consumer or a customer. The user computing system 106 can include one or more computing devices, such as laptops, smartphones, and other personal computing devices. A user computing system 106 can include executable instructions stored in one or more non-transitory computer-readable media. The user computing system 106 can also include one or more processing devices that are capable of executing program code to perform operations described herein. In various examples, the user computing system 106 can allow a user to access certain online services from a client computing system 104 or other computing resources, to engage in mobile commerce with a client computing system 104, to obtain controlled access to electronic content hosted by the client computing system 104, etc.

For instance, the user can use the user computing system 106 to engage in an electronic transaction with a client computing system 104 via an interactive computing environment. An electronic transaction between the user computing system 106 and the client computing system 104 can include, for example, the user computing system 106 being used to request online storage resources managed by the client computing system 104, acquire cloud computing resources (e.g., virtual machine instances), and so on. An electronic transaction between the user computing system 106 and the client computing system 104 can also include, for example, query a set of sensitive or other controlled data, access online financial services provided via the interactive computing environment, submit an online credit card application or other digital application to the client computing system 104 via the interactive computing environment, operating an electronic tool within an interactive computing environment hosted by the client computing system (e.g., a content-modification feature, an application-processing feature, etc.).

In some aspects, an interactive computing environment implemented through a client computing system 104 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and transaction management workflows, electronic fund transfers, etc. A user computing system 106 can be used to request access to the interactive computing environment provided by the client computing system 104, which can selectively grant or deny access to various electronic functions. Based on the request, the client computing system 104 can collect data associated with the user and communicate with the risk assessment server 118 for risk assessment. Based on the risk indicator predicted by the risk assessment server 118, the client computing system 104 can determine whether to grant the access request of the user computing system 106 to certain features of the interactive computing environment.

In a simplified example, the system depicted in FIG. 1 can configure a neural network to be used both for accurately determining risk indicators, such as credit scores, using predictor variables, and determining adverse action codes or other explanation codes for the predictor variables. A predictor variable can be any variable predictive of risk that is associated with an entity. Any suitable predictor variable that is authorized for use by an appropriate legal or regulatory framework may be used.

Examples of predictor variables used for predicting the risk associated with an entity accessing online resources include, but are not limited to, variables indicating the demographic characteristics of the entity (e.g., name of the entity, the network or physical address of the company, the identification of the company, the revenue of the company), variables indicative of prior actions or transactions involving the entity (e.g., past requests of online resources submitted by the entity, the amount of online resource currently held by the entity, and so on.), variables indicative of one or more behavioral traits of an entity (e.g., the timeliness of the entity releasing the online resources), etc. Similarly, examples of predictor variables used for predicting the risk associated with an entity accessing services provided by a financial institute include, but are not limited to, indicative of one or more demographic characteristics of an entity (e.g., age, gender, income, etc.), variables indicative of prior actions or transactions involving the entity (e.g., information that can be obtained from credit files or records, financial records, consumer records, or other data about the activities or characteristics of the entity), variables indicative of one or more behavioral traits of an entity, etc. The time-delay neural network 120 uses these predictor variables at different time points to generate a predicted risk indicator.

The predicted risk indicator can be utilized by the service provider to determine the risk associated with the entity accessing a service provided by the service provider, thereby granting or denying access by the entity to an interactive computing environment implementing the service. For example, if the service provider determines that the predicted risk indicator is lower than a threshold risk indicator value, then the client computing system 104 associated with the service provider can generate or otherwise provide access permission to the user computing system 106 that requested the access. The access permission can include, for example, cryptographic keys used to generate valid access credentials or decryption keys used to decrypt access credentials. The client computing system 104 associated with the service provider can also allocate resources to the user and provide a dedicated web address for the allocated resources to the user computing system 106, for example, by adding it in the access permission. With the obtained access credentials and/or the dedicated web address, the user computing system 106 can establish a secure network connection to the computing environment hosted by the client computing system 104 and access the resources via invoking API calls, web service calls, HTTP requests, or other proper mechanisms.

Each communication within the operating environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The numbers of devices depicted in FIG. 1 are provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the network training server 110 and the risk assessment server 118, may be instead implemented in a signal device or system.

Examples of Operations Involving Machine-Learning

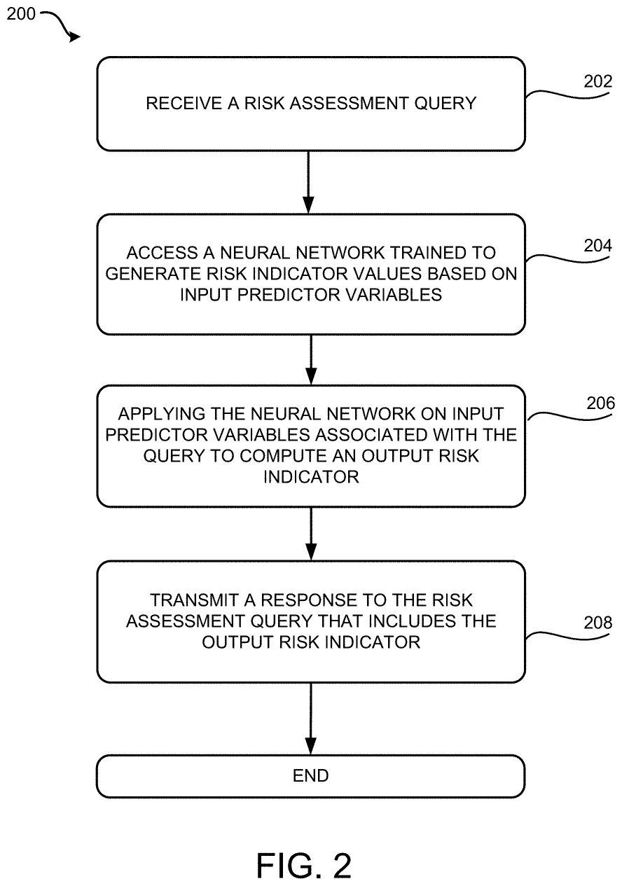

FIG. 2 is a flow chart depicting an example of a process 200 for utilizing an explainable time-delay neural network to generate risk indicators for a target entity based on multiple instances of predictor variables associated with the target entity. One or more computing devices (e.g., the risk assessment server 118) implement operations depicted in FIG. 2 by executing suitable program code (e.g., the risk assessment application 114). For illustrative purposes, the process 200 is described with reference to certain examples depicted in the figures. Other implementations, however, are possible.

At block 202, the process 200 involves receiving a risk assessment query for a target entity from a remote computing device, such as a computing device associated with the target entity requesting the risk assessment. The risk assessment query can also be received by the risk assessment server 118 from a remote computing device associated with an entity authorized to request risk assessment of the target entity.

At operation 204, the process 200 involves accessing an explainable time-delay neural network trained to generate risk indicator values based on instances of input predictor variables or other data suitable for assessing risks associated with an entity. As discussed above, examples of predictor variables can include data associated with an entity that describes prior actions or transactions involving the entity (e.g., information that can be obtained from credit files or records, financial records, consumer records, or other data about the activities or characteristics of the entity), behavioral traits of the entity, demographic traits of the entity, or any other traits that may be used to predict risks associated with the entity. In some aspects, predictor variables can be obtained from credit files, financial records, consumer records, etc. The risk indicator can indicate a level of risk associated with the entity, such as a credit score of the entity.

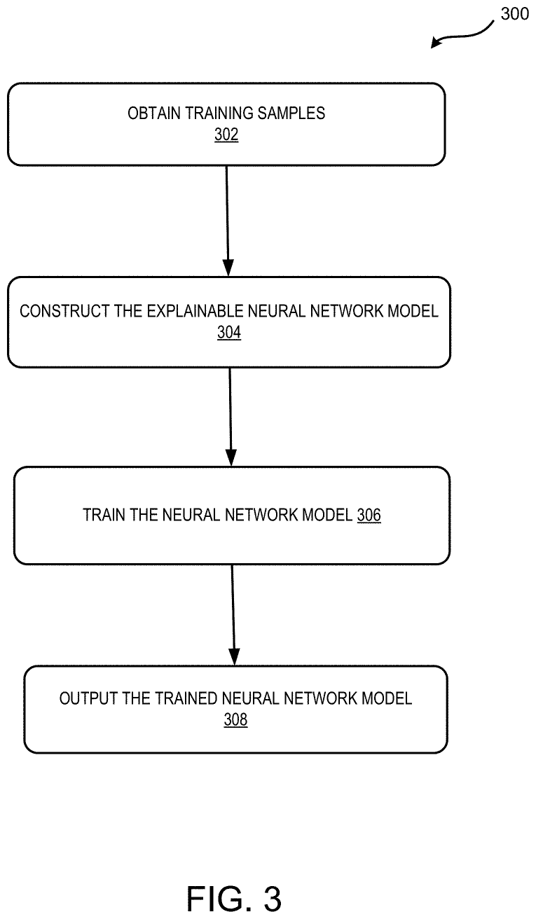

The neural network can be constructed and trained based on training samples including training predictor variables (including values at a sequence of time points) and training risk indicator outputs. A mechanism can be utilized to enforce the explainability of the neural network. For example, constraints can be imposed on the training of the neural network so that the neural network maintains a monotonic relationship between inputs to the decision network of the time-delay neural network and the risk indicator outputs. Additional details regarding training the neural network will be presented below with regard to FIG. 3.

At operation 206, the process 200 involves applying the neural network to generate a risk indicator for the target entity specified in the risk assessment query. Predictor variables associated with the target entity at different time points can be used as inputs to the neural network. The predictor variables associated with the target entity can be obtained from a predictor variable database configured to store predictor variables associated with various entities over a period of time. The output of the neural network would include the risk indicator for the target entity based on values of these predictor variables over a period of time.

At operation 208, the process 200 involves generating and transmitting a response to the risk assessment query. The response can include the risk indicator generated using the neural network. The risk indicator can be used for one or more operations that involve performing an operation with respect to the target entity based on a predicted risk associated with the target entity. In one example, the risk indicator can be utilized to control access to one or more interactive computing environments by the target entity. As discussed above with regard to FIG. 1, the risk assessment computing system 130 can communicate with client computing systems 104, which may send risk assessment queries to the risk assessment server 118 to request risk assessment. The client computing systems 104 may be associated with technological providers, such as cloud computing providers, online storage providers, or financial institutions such as banks, credit unions, credit-card companies, insurance companies, or other types of organizations. The client computing systems 104 may be implemented to provide interactive computing environments for customers to access various services offered by these service providers. Customers can utilize user computing systems 106 to access the interactive computing environments thereby accessing the services provided by these providers.

For example, a customer can submit a request to access the interactive computing environment using a user computing system 106. Based on the request, the client computing system 104 can generate and submit a risk assessment query for the customer to the risk assessment server 118. The risk assessment query can include, for example, an identity of the customer and other information associated with the customer that can be utilized to generate or otherwise obtain predictor variables. The risk assessment server 118 can perform a risk assessment based on different instances of the predictor variables generated for the customer and return the predicted risk indicator to the client computing system 104.

Based on the received risk indicator, the client computing system 104 can determine whether to grant the customer access to the interactive computing environment. If the client computing system 104 determines that the level of risk associated with the customer accessing the interactive computing environment and the associated technical or financial service is too high, the client computing system 104 can deny access by the customer to the interactive computing environment. Conversely, if the client computing system 104 determines that the level of risk associated with the customer is acceptable, the client computing system 104 can grant access to the interactive computing environment by the customer and the customer would be able to utilize the various services provided by the service providers. For example, with the granted access, the customer can utilize the user computing system 106 to access clouding computing resources, online storage resources, web pages, or other user interfaces provided by the client computing system 104 to execute applications, store data, query data, submit an online digital application, operate electronic tools, or perform various other operations within the interactive computing environment hosted by the client computing system 104.

In other examples, the explainable time-delay neural network can also be utilized to generate adverse action codes or other explanation codes for the predictor variables. Adverse action code can indicate an effect or an amount of impact that a predictor variable has or a group of predictor variables have on the value of the risk indicator, such as credit score (e.g., the relative negative impact of the predictor variable(s) on a risk indicator such as the credit score). In some aspects, the risk assessment application uses the neural network to provide adverse action codes that are compliant with regulations, business policies, or other criteria used to generate risk evaluations. Examples of regulations to which the neural network conforms and other legal requirements include the Equal Credit Opportunity Act (“ECOA”), Regulation B, and reporting requirements associated with ECOA, the Fair Credit Reporting Act (“FCRA”), the Dodd-Frank Act, and the Office of the Comptroller of the Currency (“OCC”).

In some implementations, the explanation codes can be generated for a subset of the predictor variables that have the highest impact on the risk indicator. For example, the risk assessment application 114 can determine the rank of each predictor variable based on the impact of the predictor variable on the risk indicator. A subset of the predictor variables including a certain number of highest-ranked predictor variables can be selected and explanation codes can be generated for the selected predictor variables. The risk assessment application 114 may provide recommendations to a target entity based on the generated explanation codes. The recommendations may indicate one or more actions that the target entity can take to improve the risk indicator (e.g., improve a credit score).

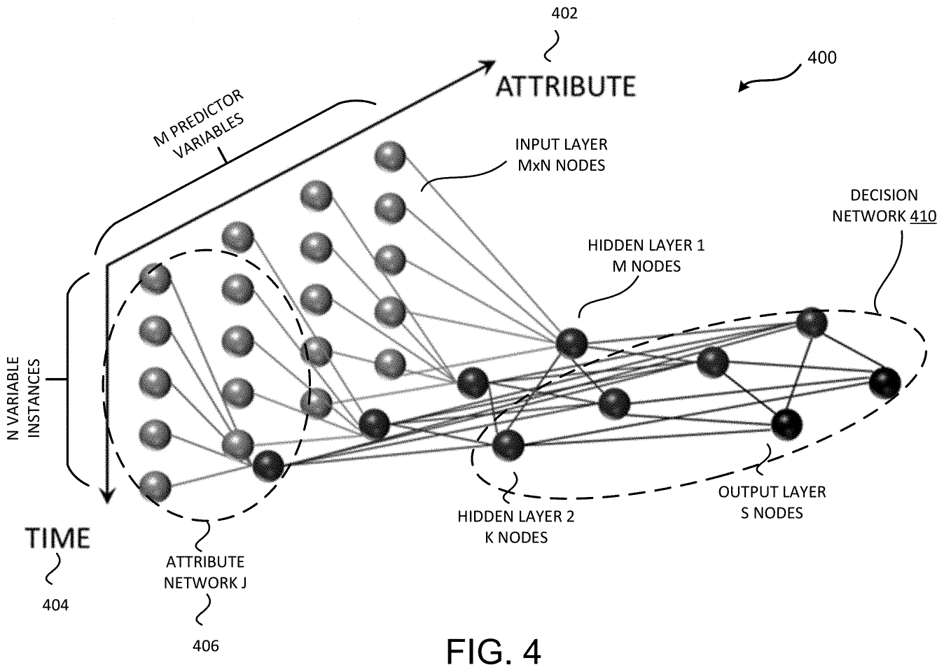

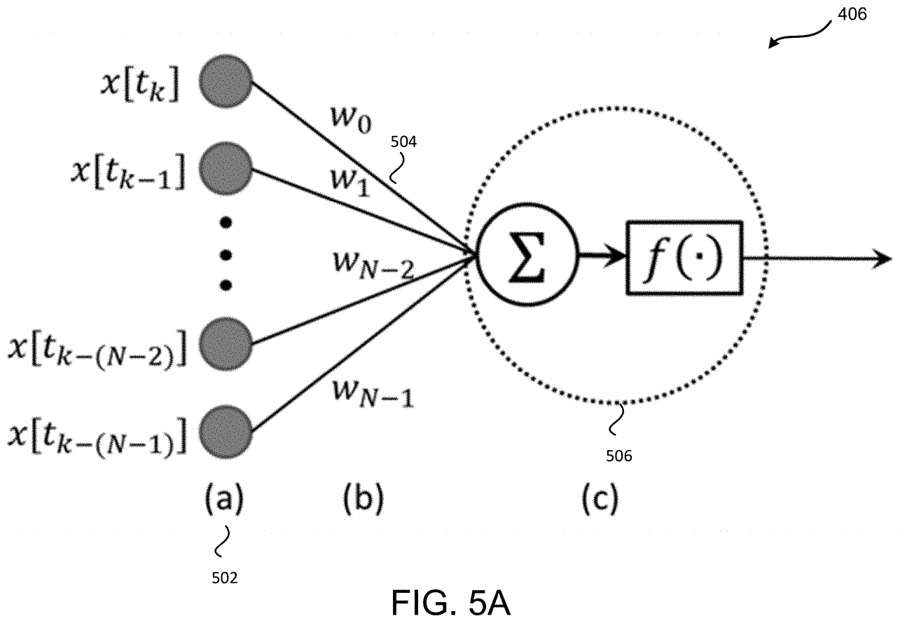

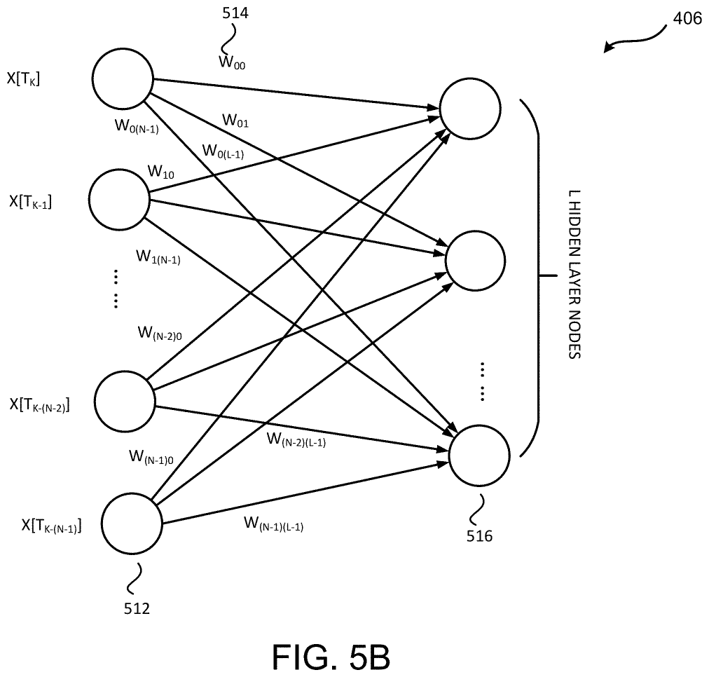

Referring now to FIG. 3, a flow chart depicting an example of a process 300 for building and training an explainable time-delay neural network is presented. FIG. 3 will be presented in conjunction with FIG. 4 where a diagram depicting an example of a time-delay neural network 400 is presented and FIGS. 5A-5B where diagrams depicting examples of an attribute network are presented. One or more computing devices (e.g., the network training server 110) implement operations depicted in FIG. 3 by executing suitable program code (e.g., the network training application 112). For illustrative purposes, the process 300 is described with reference to certain examples depicted in the figures. Other implementations, however, are possible.

At block 302, the process 300 involves the network training server 110 obtaining training samples for the neural network model. The training samples can include multiple training vectors containing training predictor variables and known outputs Y (i.e., training risk indicators). A training vector X includes M sub-vectors for M predictor variables, i.e., X=[X⁽¹⁾, X⁽²⁾, . . . , X^{(M)}]. Each sub-vector X^{(m)}, m=1, . . . , M corresponds to a predictor variable. A sub-vector includes N predictor variable instances X^{(m)}=[Xₜ_{ₖ}^{(m)}, . . . , Xₜ_{_{k-(N-1)}}^{(m)}] which are predictor variable values at N different moments of time tₖ, tₖ₋₁, . . . , t_{k-(N-1)}. In this case, N time-delays are used for the input layer of the neural network. In some examples, the time step or interval between variable instances, expressed as Δt=tₖ-tₖ₋₁, is constant. Depending on the type of the predictor variable, Δt can take a value such as, a day, a week, a month or 3 months. Each of the training samples also includes a corresponding training output Y, i.e., a training risk indicator or outcome corresponding to the input predictor vector X.

The training samples can be generated based on a dataset containing various variables associated with different entities or individuals over a period of time and the associated risk indicators. In some examples, the training samples are generated to only include predictor variables X that are appropriate and allowable for predicting Y. These appropriate and allowable predictor variables can be selected based on regulatory requirements, business requirements, contractual requirements, or any combination thereof. In some scenarios, values of some predictor variables may be missing in the dataset. These missing values can be handled by substituting these values with values that logically are acceptable, filling these values with values received from a user interface, or both. In other examples, the data records with missing values are removed from the training samples.

At block 304, the process 300 involves the network training server 110 determining the parameters of the neural network model to construct the neural network and formulating an optimization problem for the neural network model. The parameters of the neural network model can include architectural parameters of the neural network model. Examples of architectural parameters of the neural network can include the number of layers in the neural network, the number of nodes in each layer, the activation functions for each node, or some combination thereof. For instance, the number of the input variables and the number of time-delays for each input variable can be utilized to determine the number of nodes in the input layer. For an input predictor vector having M input variables and each has N instances, the input layer of the neural network can be constructed to have M×N nodes, corresponding to the M×N input variable instances. In some examples, an additional node may be added to the input layer for a constant. Likewise, the number of outputs in a training sample can be utilized to determine the number of nodes in the output layer, that is, one node in the output layer corresponds to one output. Other aspects of the neural network, such as the number of hidden layers, the number of nodes in each hidden layer, and the activation function at each node can be determined based on various factors such as the complexity of the prediction problem, available computation resources, accuracy requirement, and so on.

FIG. 4 illustrates a diagram depicting an example of a time-delay neural network 400. A neural network model is a memory structure comprising nodes connected via one or more layers. In this example, the neural network 400 includes an input layer having M×N nodes each corresponding to a training predictor variable instance. The M×N nodes are organized into M groups corresponding to the M predictor variables along the attribute dimension 402. In each group, there are N nodes representing the N time instances of the corresponding predictor variable along the time dimension 404. The neural network 400 further includes a first hidden layer having M nodes or M sets of nodes, each node or each set of nodes corresponding to a predictor variable, a second hidden layer having K nodes, and an output layer for S outputs. In the example described above with respect to FIGS. 1 and 2, the output layer can include a single node for the output Y (i.e., the risk indicator or outcome). The connections between nodes in different layers are associated with respective weights to determine the inputs to a current layer based on the output of the previous layer.

In the neural network 400, the input nodes in one group and the corresponding node or set of nodes in the first hidden layer form an attribute network 406. In the example shown in FIG. 4, since there are four groups (i.e., four predictor variables), there are four attribute networks. FIG. 5A illustrates an example of an attribute network 406 for a predictor variable x. In this example, the attribute network 406 includes N input layer nodes 502 corresponding to the N instances of the predictor variable x. The N input layer nodes receive the N values of the predictor variable x at time points tₖ, tₖ₋₁, . . . , t_{k-(N-1)}. These values pass through the connections 504 between the respective input layer nodes 502 and the hidden layer node 506. These N connections are associated with weights w₀, w₁, . . . , w_{N-1}, respectively. The hidden layer node 506 sums together the N weighted variable instances and passes the sum through an activation function ƒ(·). In some examples, the activation function ƒ(·) is a differentiable nonlinear function, such as hyperbolic tangential functions or sigmoidal functions. Other types of activation functions can also be utilized. Examples of activation functions include, but are not limited to, the logistic, arc-tangent, and hyperbolic tangent functions.

FIG. 5B illustrates another example of the attribute network 406 for a predictor variable x. In this example, the attribute network 406 includes N input layer nodes 512 corresponding to the N instances of the predictor variable x and M hidden layer nodes 516. Each of the M hidden layer nodes 516 can be connected to nodes in the next hidden layer of the network 400. In some examples, the hidden layer nodes 516 in different attribute networks are disjoint in that a node in the input layer of one attribute network is not connected to a node in the hidden layer of another attribute network. The N input layer nodes in the attribute network 406 receive the N values of the predictor variable x at time points tₖ, tₖ₋₁, . . . , t_{k-(N-1)}. These values pass through the connections 514 between the input layer nodes 512 and the hidden layer nodes 516. Each of these connections is associated with a weight wᵢⱼ. Each of the hidden layer nodes 516 is configured in a way similar to the hidden layer node 506 to sum together the N weighted variable instances and pass the sum through an activation function ƒ(·).

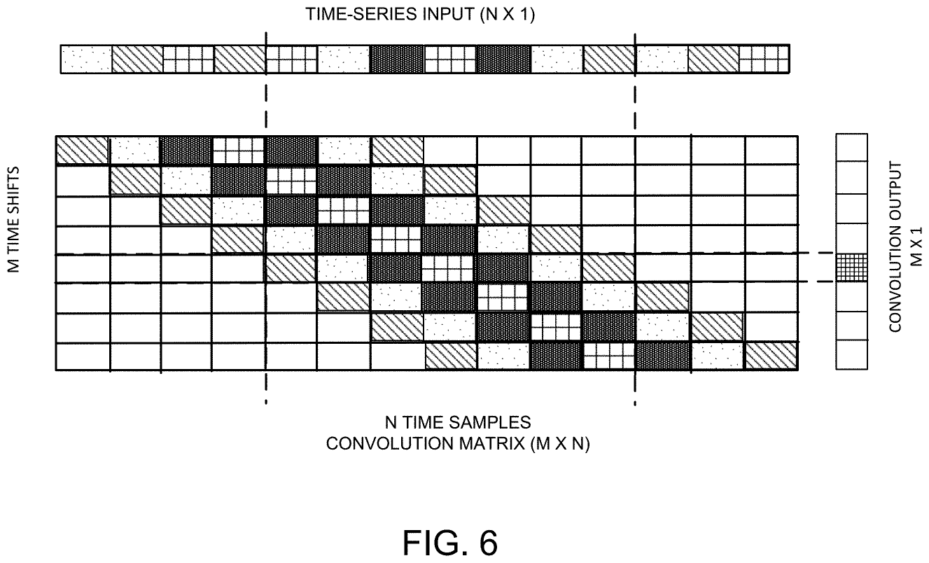

In some examples, the attribute network 406 is configured to apply a convolution operation on the input sequence of N values of the predictor variable to identify predictive features in the sequence of predictor variable values. These predictive features can be time-series templates that are cross-correlated with the input time-series. The templates can be time-shifted across the input one shift at a time and the result indicates a metric of how well the template matches the input at each time shift. The convolution can be represented as a matrix operation on the input time-series for the predictor variable, as illustrated in FIG. 6. The matrix has dimensions M by N with a Toeplitz structure, for which each row is a shifted version of the same template. Each row represents the weights of the connections to one hidden layer node 516. The output vector has M elements that correspond to the M time shifts. To implement the convolution operation, a constraint can be imposed on the weights connected to the hidden layer nodes in the attribute network. The constraint can specify that the set of weights connected to one hidden layer node is a shifted version of the set of weights connected to another hidden layer node. In this way, the M time shifts can be implemented by the M hidden layer nodes in the attribute network. As discussed above, each hidden node further passes the output of the convolution (i.e., the sum) through the activation function ƒ(·) to generate the output of the attribute network 406.

The outputs of the attribute network 406 are passed along to the next hidden layer of the network 400 which further provides data to the output layer as shown in FIG. 4. In some examples, the hidden layers of the network 400 that are not part of an attribute network and the output layer form a decision network 410, which can be trained separately or jointly with the attribute networks 406.

For illustrative purposes, the neural network 400 illustrated in FIG. 4 and described above includes two hidden layers and two outputs. Neural networks with any number of hidden layers and any number of outputs can be formulated in a similar way, and the following analysis can be performed accordingly. Further, the hidden layers of the neural network 400 can have any differentiable sigmoid activation function that accepts real number inputs and outputs a real number. Different layers of the neural network can employ the same or different activation functions.

Referring back to FIG. 3, at block 306, the process 300 involves training the neural network model 400. For example, the network training server 110 constructs an optimization problem for the neural network model 400. Training a neural network can include solving the optimization problem to find the parameters of the neural network, such as the weights of the connections in the neural network so that a loss function of the neural network 400 is minimized. The loss function can be defined as, or as a function of, the difference between the outputs predicted using the neural network with its current weights and the observed output in the training samples. In some aspects, the loss function can be defined as the negative log-likelihood of the neural network distortion between the predicted value of the output and the observed output values. In some examples, the loss function also includes a L1-norm regularization of the learned features at the output layer. The regularization can reduce the amount of overfitting in the model by finding a sparse solution. That is, the features that do not contribute significantly to the model output will have their corresponding weights in the logistic regression layer driven to zero.

In some examples, the decision network 410 can be trained to be a monotonic network such that each input (and thus the output of an attribute network) to the first hidden layer of the decision network 410 has a monotonic relationship with the output of the decision network 410 (and thus the output of the neural network 400). To ensure the monotonic relationship between the input and the output of the decision network, the network training server 110 is configured to implement additional mechanisms in the training process. For example, a constraint can be added to the optimization problem of minimizing the loss function of the neural network described above to enforce the monotonicity of the neural network. The monotonicity can be enforced by enforcing the partial derivative of the output over each input of the decision network to be non-negative. In some cases, the impact of an input on the output of the neural network can be determined, at least in part, by the weights along the paths from the input node corresponding to a variable instance to the output node. These weights include the weight from a node in the last layer of the attribute network to a node in the first hidden layer of the decision network, the weight from a node in the first hidden layer node to a node in the next hidden layer, and the weight from the node in the last hidden layer to the output layer node.

The constraint of the monotonicity between an input and the output can be imposed on these weights so that the product of weights along any path from the input variable instance to the output is greater than or equal to 0. This can be mathematically denoted as Πₗ₌₁^{L} wᵢⱼ^{(l)}≥0, where wᵢⱼ^{(l)} is the weight from node i in the (l-1)-th layer to node j in the l-th layer of the neural network. In this way, the impact of the input predictor variable instance on the output can be made to be always non-negative. Note the monotonic constraint can also be enforcing the product of weights along any path from the input to the output is smaller than or equal to 0. Details on solving this constrained optimization problem can be found, for example, in U.S. Pat. No. 10,558,913 issued on Feb. 11, 2020, entitled “Machine-learning techniques for monotonic neural networks,” the disclosure of which is hereby incorporated by reference in its entirety.

By enforcing the training of the neural network to satisfy the specific rules set forth in the monotonic constraint, a special neural network structure can be established that inherently carries the monotonic property. There is thus no need to perform additional adjustment of the neural network for monotonicity purposes described in the first example. As a result, the training of the neural network can be completed with fewer operations and thus requires fewer computational resources.

At block 310, the process 300 involves the network training server 110 outputting the neural network 120. The network training server 110 can also record the optimized weight vector for use by the neural network model to perform a prediction based on future input predictor variables.

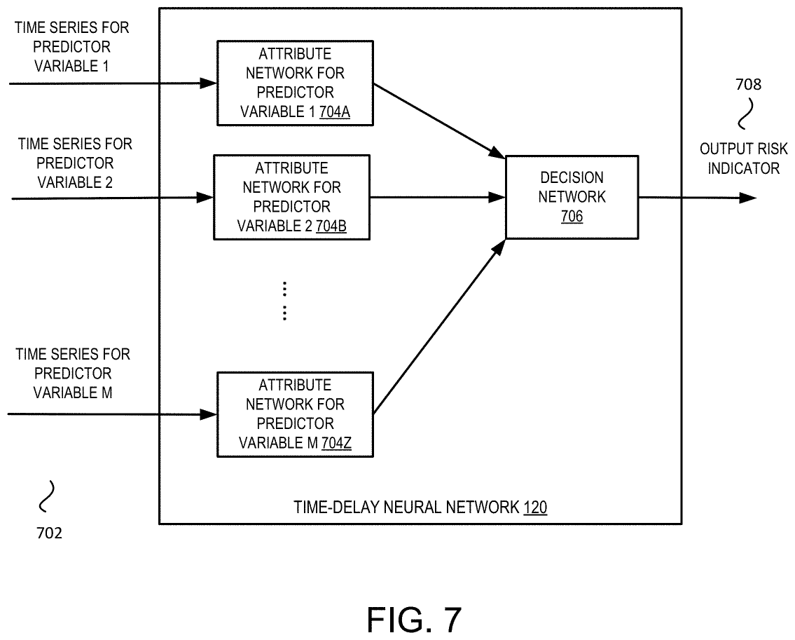

FIG. 7 shows a block diagram illustrating components of a time-delay neural network 120. As discussed above, a time-delay neural network 120 can include multiple attribute networks 704A-Z, each corresponding to a predictor variable, and a decision network 706. Each of the attribute networks can be configured to accept a time-series data of the corresponding predictor variable and generate an input to the decision network 706. In some examples, each of the attribute networks is configured to perform convolution operation operations on the input time series data to identify features for use by the decision network 706. The decision network 706 can be configured to generate the output risk indicator 708 based on the outputs generated by the attribute networks 704.

Examples of Generating Explanatory Data with Neural Network

To generate explanatory data, such as reason codes, techniques can be utilized to compute the impact of individual predictor variables on the risk indicator. The explanatory data can include two parts: one from the decision network 706 and one from the attribute networks 704. As discussed above, the decision network 706 can be trained to be a monotonic network such that a monotonic relationship exists between each input of the decision network 706 and the output risk indicator. In other words, an increase in an input always leads to an increase (or decrease) in the output risk indicator or vice versa. A “points below max” approach that can be used to determine the explanatory data for the decision network 706. This approach can be formulated as:

$$f ( {X}_{{t}_{k}}^{( 1 )} , … , {X}_{{t}_{k - ( N - 1 )}}^{( 1 )} , … , {X}_{{t}_{k}}^{( m )} , … {X}_{{t}_{k} - n}^{* ( m )} , … , {X}_{{t}_{k - ( N - 1 )}}^{( m )} , … , {X}_{{t}_{k}}^{( M )} , … , {X}_{{t}_{k - ( N - 1 )}}^{( M )} ) - f ( {X}_{{t}_{k}}^{( 1 )} , … , {X}_{{t}_{k - ( N - 1 )}}^{( 1 )} , … , {X}_{{t}_{k}}^{( m )} , . . . {X}_{{t}_{k} - n}^{( m )} , … , {x}_{{t}_{k - ( N - 1 )}}^{( m )} , … , {X}_{{t}_{k}}^{( M )} , … , {X}_{{t}_{k - ( N - 1 )}}^{( M )} ) . \qquad ( 1 )$$

Here, ƒ(·) denotes the function or model for determining the risk indicator using the inputs. X*ₜ_{ₖ}₋ₙ^{(m)} denotes the value of the input Xₜ_{ₖ}₋ₙ^{(m)} that maximizes the risk indicator ƒ(·) when the values of other variable instances are fixed. Since ƒ(·) is monotonic in each variable instance, X*ₜ_{ₖ}₋ₙ^{(m)} will be the right or left endpoint of the domain of Xₜ_{ₖ}₋ₙ^{(m)}, depending on whether it is a positive or negative behavior instance.

To generate the explanatory data, for each input, the points below max may be computed by applying Equation (1). The resulting points are sorted in descending order and explanatory data can be generated for inputs having one of the highest points. Other similar explanation methods may be applied to rank the significance of each input on the neural network model and to generate the explanatory data.

The relationship between the predictor variables and the input to the decision network 706 (thus the output of the attribute networks) can be determined by performing analysis, such as the wavelet analysis, on the parameters of the respective attribute networks. As discussed above, each attribute network can be configured to perform a convolution operation on the input time series data to search for predictive features from the time series data. The predictive features can be time-series templates that are determined during the training of the time-delay neural network through determining the weights of connections within the attribute network. As such, analysis, such as wavelet analysis, can be performed on the weights of the connections to identify the most influencing explainable components of the predictive features. Similar analysis can be performed on the input time series data to determine metrics measuring the quantity of the most influencing explainable components contained in the input time series. Those metrics can indicate the relationship between the input time-series data and the output of the attribute network. By combining the explanatory data for the attribute networks and the decision network, explanatory data indicating the relationship between the time-series data of the predictor variables and the risk indicator can be generated.

In another example, the impact of the predictor variables on the output can be determined as follows. First, a reference time series can be created in order to represent values for each predictor variable that maximizes the risk model output. These values can be drawn from available training data so that the time series is feasible. Next, the Shapley value algorithm can be applied to calculate the marginal impact of the learned features on the model output relative to the model output from the reference time series. Upon quantifying the marginal impact of the predictor variables on the output, the predictors can be rank ordered and formulate the respective explanation codes.

In some cases, the values of the time-series data vary widely across predictor variables. Thus, a normalization of the data can be performed so that larger-valued predictor variable values do not exert an oversized influence on the model output. The time-series data can be normalized by, for each predictor variable, subtracting the mean of the time series data from itself, then dividing the result by the standard deviation of the sequence. This normalization step allows the model to estimate the relationship between the patterns present in the normalized time series data and the likelihood of the outcome.

It is noted that the risk indicator described herein is merely an example of the output of the time-delay neural network and should not be construed as limiting. The time-delay neural network may be configured and trained to generate various other types of outputs using proper training samples. For example, the outputs can be the prediction of entity behavior or other response variables. The output can have a value from a set of discrete values or a set of continuous values. In some examples, the response variable may be a random response variable from an exponential family of distributions.

In addition, the architecture of the time-delay neural network shown in FIGS. 4-5B and 7 are for illustration purposes, and the time-delay neural network may be configured with other architectures. For instance, the input layer and the first hidden layer can be constructed to be fully connected such that each node in the first hidden layer is connected to all the input layer nodes. Likewise, the architecture of the neural network can be further extended such as the first hidden layer has the same number of nodes as the input layer and each node in the first hidden layer is connected to all the input layer nodes. In other examples, multiple hidden layers can be introduced into each attribute network, with the hidden layers detecting different predictive features through convolution operations. The above-described process of training and utilizing the time-delay neural network can be applied accordingly.

Furthermore, the training and the explanatory data generation of the time-delay neural network described above are for illustration purposes and may be performed in other ways. For example, the entire time-delay neural network model can be trained to enforce a monotonic constraint on the inputs and outputs of the time-delay neural network model. The method for generating the explanatory data for the decision model described above may be used to generate the explanatory data for the time-delay neural network model. In some examples, no constraints are imposed on the weights of the attribute networks.

Example of Computing System for Machine-Learning Operations

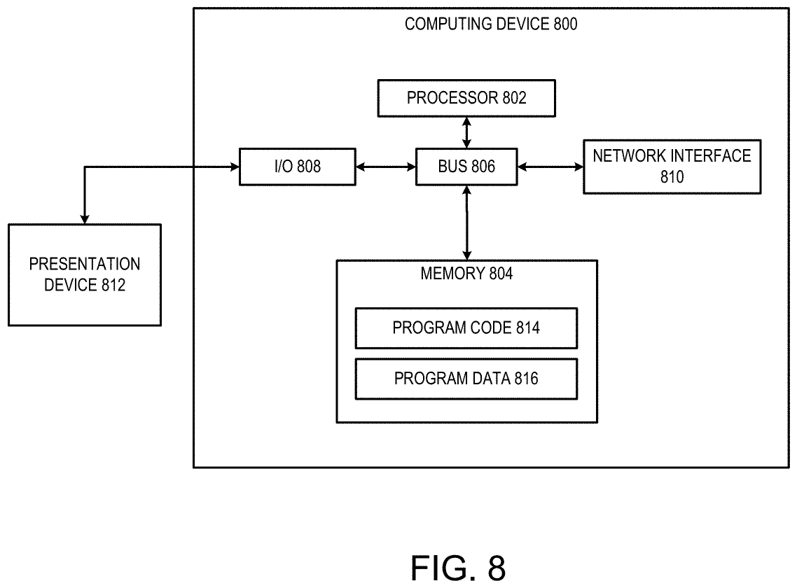

Any suitable computing system or group of computing systems can be used to perform the operations for the machine-learning operations described herein. For example, FIG. 8 is a block diagram depicting an example of a computing device 800, which can be used to implement the risk assessment server 118 or the network training server 110. The computing device 800 can include various devices for communicating with other devices in the operating environment 100, as described with respect to FIG. 1. The computing device 800 can include various devices for performing one or more transformation operations described above with respect to FIGS. 1-7.

The computing device 800 can include a processor 802 that is communicatively coupled to a memory 804. The processor 802 executes computer-executable program code stored in the memory 804, accesses information stored in the memory 804, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 802 include a microprocessor, an application-specific integrated circuit, a field-programmable gate array, or any other suitable processing device. The processor 802 can include any number of processing devices, including one. The processor 802 can include or communicate with a memory 804. The memory 804 stores program code that, when executed by the processor 802, causes the processor to perform the operations described in this disclosure.

The memory 804 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C#, Visual Basic, Java, Python, Perl, JavaScript, ActionScript, etc.

The computing device 800 may also include a number of external or internal devices such as input or output devices. For example, the computing device 800 is shown with an input/output interface 808 that can receive input from input devices or provide output to output devices. A bus 806 can also be included in the computing device 800. The bus 806 can communicatively couple one or more components of the computing device 800.

The computing device 800 can execute program code 814 that includes the risk assessment application 114 and/or the network training application 112. The program code 814 for the risk assessment application 114 and/or the network training application 112 may be resident in any suitable computer-readable medium and may be executed on any suitable processing device. For example, as depicted in FIG. 8, the program code 814 for the risk assessment application 114 and/or the network training application 112 can reside in the memory 804 at the computing device 800 along with the program data 816 associated with the program code 814, such as the predictor variables 124 and/or the neural network training samples 126. Executing the risk assessment application 114 or the network training application 112 can configure the processor 802 to perform the operations described herein.

In some aspects, the computing device 800 can include one or more output devices. One example of an output device is the network interface device 810 depicted in FIG. 8. A network interface device 810 can include any device or group of devices suitable for establishing a wired or wireless data connection to one or more data networks described herein. Non-limiting examples of the network interface device 810 include an Ethernet network adapter, a modem, etc.

Another example of an output device is the presentation device 812 depicted in FIG. 8. A presentation device 812 can include any device or group of devices suitable for providing visual, auditory, or other suitable sensory output. Non-limiting examples of the presentation device 812 include a touchscreen, a monitor, a speaker, a separate mobile computing device, etc. In some aspects, the presentation device 812 can include a remote client-computing device that communicates with the computing device 800 using one or more data networks described herein. In other aspects, the presentation device 812 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

1. A method that includes one or more processing devices performing operations comprising:
accessing time-series data of a plurality of predictor variables associated with a target entity, the time-series data of a predictor variable of the plurality of predictor variables comprising data instances of the predictor variable at a sequence of time points;
determining a risk indicator for the target entity indicating a level of risk associated with the target entity by inputting the time-series data of the plurality of predictor variables into a time-delay neural network, wherein:
the time-delay neural network comprises (a) a plurality of attribute networks, each attribute network of the plurality of attribute networks corresponding to a predictor variable of the plurality of predictor variables and (b) a decision network for generating the risk indicator from outputs of the plurality of attribute networks, and
each attribute network of the plurality of attribute networks comprises (a) input nodes in an input layer accepting the respective data instances of the predictor variable corresponding to the attribute network and (b) a set of hidden layer nodes in a hidden layer connected to the input nodes, wherein a first set of hidden layer nodes in a first attribute network of the plurality of attribute networks and a second set of hidden layer nodes in a second attribute network of the plurality of attribute networks are disjoint, and wherein weights of connections associated with the set of hidden layer nodes in each attribute network of the plurality of attribute networks are subject to a constraint; and
transmitting, to a remote computing device, a responsive message including the risk indicator for use in controlling access to one or more interactive computing environments by the target entity.

2. The method of claim 1, wherein the constraint comprises a first set of weights associated with a first hidden layer node in an attribute network is a shifted version of a second set of weights associated with a second hidden layer node in the attribute network.

3. The method of claim 1, wherein the decision network of the time-delay neural network comprises an additional hidden layer and an output layer for outputting the risk indicator, wherein nodes in the additional hidden layer are connected to the nodes in the hidden layer of the plurality of attribute networks.

4. The method of claim 3, wherein the decision network determines the risk indicator based on the outputs of the plurality of attribute networks such that a monotonic relationship exists between an output of an attribute network and the risk indicator.

5. The method of claim 4, wherein the operations further comprise:
generating, for the target entity, explanatory data indicating relationships between the risk indicator and a predictor variable of the plurality of predictor variables.

6. The method of claim 5, wherein generating the explanatory data comprises:
generating a first portion of the explanatory data using the decision network; and
generating a second portion of the explanatory data based on weights of the plurality of attribute networks.

7. The method of claim 6, wherein generating the first portion of the explanatory data comprises applying a points-below-max algorithm or a Shapley value algorithm.

8. The method of claim 6, wherein generating the second portion of the explanatory data comprises performing wavelet analysis on the weights of the plurality of attribute networks and the time-series data of the plurality of predictor variables.

9. A system comprising:
a processing device; and
a memory device in which instructions executable by the processing device are stored for causing the processing device to perform operations comprising:
accessing time-series data of a plurality of predictor variables associated with a target entity, the time-series data of a predictor variable of the plurality of predictor variables comprising data instances of the predictor variable at a sequence of time points;
determining a risk indicator for the target entity indicating a level of risk associated with the target entity by inputting the time-series data of the plurality of predictor variables into a time-delay neural network, wherein:
the time-delay neural network comprises (a) a plurality of attribute networks each attribute network of the plurality of attribute networks corresponding to a predictor variable of the plurality of predictor variables and (b) a decision network for generating the risk indicator from outputs of the plurality of attribute networks, and
each attribute network of the plurality of attribute networks comprises (a) input nodes in an input layer configured for accepting the respective data instances of the predictor variable corresponding to the attribute network and (b) a set of hidden layer nodes in a hidden layer configured to connect to the input nodes, wherein a first set of hidden layer nodes in a first attribute network of the plurality of attribute networks and a second set of hidden layer nodes in a second attribute network of the plurality of attribute networks are configured to be disjoint, and wherein weights of connections associated with the set of hidden layer nodes in each attribute network of the plurality of attribute networks are configured to be subject to a constraint; and
transmitting, to a remote computing device, a responsive message including the risk indicator for use in controlling access to one or more interactive computing environments by the target entity.

10. The system of claim 9, wherein the constraint comprises a first set of weights associated with a first hidden layer node in an attribute network is a shifted version of a second set of weights associated with a second hidden layer node in the attribute network.

11. The system of claim 9, wherein the decision network of the time-delay neural network comprises an additional hidden layer and an output layer for outputting the risk indicator, wherein nodes in the additional hidden layer are configured to connect to the nodes in the hidden layer of the plurality of attribute networks.

12. The system of claim 11, wherein the decision network is configured to determine the risk indicator based on the outputs of the plurality of attribute networks such that a monotonic relationship exists between an output of an attribute network and the risk indicator.

13. The system of claim 12, wherein the operations further comprise:
generating, for the target entity, explanatory data indicating relationships between the risk indicator and a predictor variable of the plurality of predictor variables.

14. The system of claim 13, wherein the operation of generating the explanatory data comprises:
generating a first portion of the explanatory data using the decision network; and
generating a second portion of the explanatory data based on weights of the plurality of attribute networks.

15. A non-transitory computer-readable storage medium having program code that is executable by a processor device to cause a computing device to perform operations, the operations comprising:
accessing time-series data of a plurality of predictor variables associated with a target entity, the time-series data of a predictor variable of the plurality of predictor variables comprising data instances of the predictor variable at a sequence of time points;
determining a risk indicator for the target entity indicating a level of risk associated with the target entity by inputting the time-series data of the plurality of predictor variables into a time-delay neural network, wherein:
the time-delay neural network comprises (a) a plurality of attribute networks each attribute network of the plurality of attribute networks corresponding to a predictor variable of the plurality of predictor variables and (b) a decision network configured to generate the risk indicator from outputs of the plurality of attribute networks, and
each attribute network of the plurality of attribute networks comprises (a) input nodes in an input layer accepting the respective data instances of the predictor variable corresponding to the attribute network and (b) a set of hidden layer nodes in a hidden layer configured to connect to the input nodes, wherein a first set of hidden layer nodes in a first attribute network of the plurality of attribute networks and a second set of hidden layer nodes in a second attribute network of the plurality of attribute networks are configured to be disjoint, and wherein weights of connections associated with the set of hidden layer nodes in each attribute network of the plurality of attribute networks are configured to be subject to a constraint; and
transmitting, to a remote computing device, a responsive message including the risk indicator for use in controlling access to one or more interactive computing environments by the target entity.

16. The non-transitory computer-readable storage medium of claim 15, wherein the constraint comprises a first set of weights associated with a first hidden layer node in an attribute network is a shifted version of a second set of weights associated with a second hidden layer node in the attribute network.

17. The non-transitory computer-readable storage medium of claim 15, wherein the decision network of the time-delay neural network comprises an additional hidden layer and an output layer for outputting the risk indicator, wherein nodes in the additional hidden layer are connected to the nodes in the hidden layer of the plurality of attribute networks.

18. The non-transitory computer-readable storage medium of claim 17, wherein the decision network is configured to determine the risk indicator based on the outputs of the plurality of attribute networks such that a monotonic relationship exists between an output of an attribute network and the risk indicator.

19. The non-transitory computer-readable storage medium of claim 18, wherein the operations further comprise:
generating, for the target entity, explanatory data indicating relationships between the risk indicator and a predictor variable of the plurality of predictor variables.

20. The non-transitory computer-readable storage medium of claim 19, wherein the operation of generating the explanatory data comprises:
generating a first portion of the explanatory data using the decision network; and
generating a second portion of the explanatory data based on weights of the plurality of attribute networks.
